(19) United States
(12) Patent Application Publication
(10) Pub. No.: US 2008/0159142 A1
(43) Pub. Date: Jul. 3, 2008

(54) LINK ACCESS DELAY AWARE ROUTING OVER MOBILE AD HOC NETWORKS (MANETS)

(75) Inventors: Ramesh Nagarajan, Princeton Junction, NJ (US); Shyam P. Parekh, Orinda, CA (US); Kiran M. Rege, Marlboro, NJ (US)

Correspondence Address: SYNNESTVEDT & LECHNER, LLP, 1101 MARKET STREET, SUITE 2600, PHILADELPHIA, PA, 19107-2950, US

(73) Assignee: LUCENT TECHNOLOGIES INC., Murray Hill, NJ (US)

(21) Appl. No.: 11/617,849

(22) Filed: Dec. 29, 2006

(51) Int. Cl. G08C 15/00

(52) U.S. Cl. 370/235

(57) ABSTRACT

The present invention provides a method and apparatus for routing a data flow from a source node to a destination node in a mobile ad-hoc network (MANET). The present invention performs this function by first determining a quantitative value for each link at a corresponding origination node, where the value represents the current performance level of the links. Next, the present invention broadcasts an advertisement for each of the links in the MANET by the corresponding origination nodes, the advertisement including the value determined above. After broadcasting the advertisements, routing tables are composed at each of the nodes based upon the advertisements. Each routing table is constructed taking into account the advertised links and their corresponding values. After composing the routing tables, packets are forwarded toward their respective destinations in accordance with the next hops indicated by the routing table.

### FIELD OF THE INVENTION

The invention pertains to packet routing over Mobile Ad Hoc Networks (MANETs).

### BACKGROUND OF THE INVENTION

A MANET is a highly dynamic and constantly evolving network in which a collection of wireless mobile nodes form a network without any fixed infrastructure. A MANET is useful in a situation in which it is economically or physically impractical to provide a fixed infrastructure, such as for emergency workers during a hurricane or for soldiers on a battlefield. Such conditions provide no opportunity for a permanent infrastructure, which makes the mobile aspect of a MANET ideal. Efficient routing over MANETs has been a focus of research in recent years.

Quality of service (QoS) requirements of MANETs have also been a focus of research in the data networking community as interest in real-time applications over minimal infrastructure networks, such as MANETs, has increased. One specific application where QoS is of particular concern is voice over IP (VoIP). VoIP is essentially telephone service over the Internet, i.e., utilizing a data network connection to make real time telephone calls. In the two above situations, utilizing a MANET to carry VoIP data flows is beneficial as it provides contact to soldiers or emergency workers who may be far from a fixed contact point. By utilizing nodes in the MANET, the VoIP data flow can be routed to its destination despite the lack of a permanent communication infrastructure.

One popular routing protocol for MANETs is the Optimized Link State Routing (OLSR) protocol. OLSR is explained in “Optimized Link State Routing Protocol (OLSR)” by Clausen & Jacquet, RFC 3626, published October 2003, and available on the internet at “http://ietf.org/rfc/rfc3626.txt”. In a MANET, a link is any outgoing path from an individual node to another node. OLSR is a proactive routing protocol that propagates partial link state information through a MANET to support hop-by-hop packet forwarding based on the “min-hop” criterion. “Min-hop” essentially means minimum hop, or selecting a route based on the fewest hops between source and destination, regardless of the quality of the links used for each hop. Note that as long as a link is considered alive, as determined, for example, by the reception of a minimum number of hello messages in some time period, the OLSR protocol advertises it and uses it in the construction of routing tables, regardless of the quality of that link. Thus, during some topology changes, for instance, a link may go through long periods of low link quality before being considered “dead.” Any source node utilizing this advertised weak link in its routing tables risks packet delays and packet losses, both of which cause degradation to the data flow. In the above case where a MANET is used to carry a VoIP data flow, excessive packet delays and packet losses may cause an individual VoIP data flow to be completely lost.

The basic algorithm underlying routing table calculations in OLSR attempts to minimize path lengths between source-destination pairs by selecting routes with the smallest number of hops between source and destination nodes without concern for link quality. What is needed is a method of determining the quality of a link in a MANET before constructing the routing table, and advertising any available link in the routing table along with its current quality level.

### SUMMARY OF THE INVENTION

The OLSR routing protocol in a MANET is improved, in accordance with the principles of the present invention, by looking not only for a “min-hop” route, but also taking into account the path delay characteristics. The routing table calculation of the OLSR protocol is adapted to utilize a calculated delay metric to evaluate links in the routing table such that paths with good delay characteristics are preferentially selected.

The delay metric based routing is based on the Media Access Delay for packets being transmitted out of a node, where the Media Access Delay is defined as the sum of the queuing delay at the Media Access Control (MAC) layer due to transmission times and contention delays of proceeding packets and the queuing delay at the Internet Protocol (IP) layer. For each packet, the total delay is recorded when the packet is sent to the physical layer of the node for the first time. The measured media access delays for different packets are averaged using a suitable averaging technique, e.g. exponential averaging. The average media access delays are maintained for each link that is considered to be “alive”, or active, according to the routing protocol.

In one embodiment of the invention, a node, after determining the average media access delay for each of its links to neighboring nodes, includes in a link-state advertisement the average media access delay for each of its links. When nodes in the network receive link-state advertisements and carry out routing table computations, they only consider those links for which the advertised average media access delay is less than a certain threshold, e.g., 30 ms. As a consequence, only good-quality links, i.e., those for which the average media access delay is within the acceptance threshold, appear in routing tables.

In another embodiment of the invention, a node, after determining the average media access delay for each of its links, converts these average delay values into length metrics, and includes in its link-state advertisements the length metrics for each of its links that are considered active by the routing protocol (OLSR). Utilizing this information at the time of routing table construction, the OLSR protocol can create a routing table that can be used to find a path for a source-destination pair that minimizes the sum of length metrics of the links incident on the path. Advantageously, the objective of selecting routes with minimum path lengths increases the likelihood of using good-quality links, i.e. those with small length metrics, rather than poor-quality paths with large lengths. As a consequence, to the extent possible, packets are forwarded along good-quality links.

### BRIEF DESCRIPTION OF THE DRAWINGS

FIG. 1 is a block diagram illustrating a MANET.

FIG. 2 is a flow chart illustrating the actions of a node according to one embodiment of the present invention.

FIG. 3 is a flow chart illustrating the actions of a node according to a second embodiment of the present invention.

FIG. 4 is a graph illustrating a particular link metric as a function of media access delay as calculated in accordance with the second embodiment of the present invention.

### DETAILED DESCRIPTION OF THE INVENTION

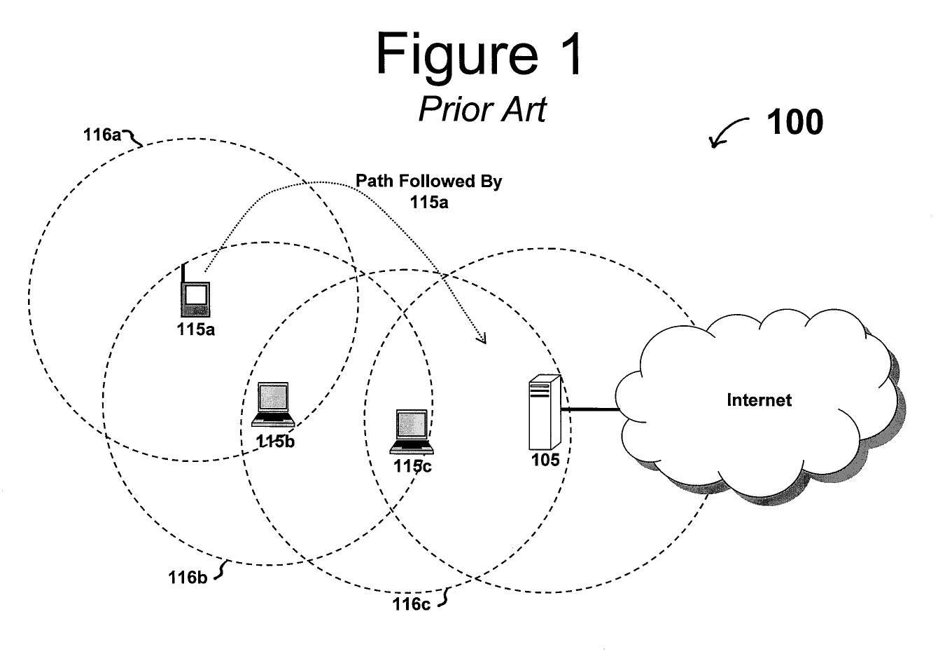

MANETs are highly dynamic, with frequent topology changes as nodes move into or out of the transmission range of other nodes. FIG. 1 illustrates MANET. Here, MANET 100 is used by mobile devices to communicate with one another and to access the Internet 107. Gateway 105 allows nodes, i.e., mobile devices, in MANET 100 to access the Internet 107.

A MANET predominantly comprises mobile devices, e.g., 115a, 115b and 115c as shown in FIG. 1. In this example, 115a is a personal digital assistance (PDA) while 115b and 115c are laptop computers. The mobile devices 115a, 115b and 115c are nodes of MANET 100. However, one feature that distinguishes a MANET from a typical wireless network, e.g., a wireless LAN, is that, in a MANET, each node acts as a source or destination of data as well as a router. Mobile devices can directly communicate with one another if they are within each other's transmission range 116; otherwise, communications between them follow a multi-hop path where data packets originating at the source node are received at intermediate nodes and then forwarded toward the destination by the intermediate nodes on the path between the source and the destination nodes. For instance, in FIG. 1, nodes 115a and 115c are not within each other's transmission range 116a and 116c. As a consequence, if node 115a wishes to communicate with node 115c, it sends its data packets to node 115b, which is within node 115a's transmission range 116a; node 115b receives these packets and transmits them to node 115c which is in its, node 115b's, transmission range 116b. As mentioned before, communications between nodes in MANET 100 and servers and devices in the Internet 107 pass through the Gateway 105. Communications between nodes of MANET 100 do not involve Gateway 105. Note that a stand-alone MANET, where the nodes communicate with one another only and not with external devices, need not include a Gateway such as the Internet Gateway 105 shown in FIG. 1.

In a realistic MANET, hundreds or thousands of nodes may be present. A remote node may have numerous links to use to connect to another node, or an Internet Gateway such as 105 in FIG. 1. Typical routing techniques utilize a minimum hop routing protocol, where a source-destination route is chosen based upon the smallest number of hops, or intermediate nodes, between the source and destination nodes. This technique ignores the current conditions of the network such as individual link traffic and overall performance of individual nodes.

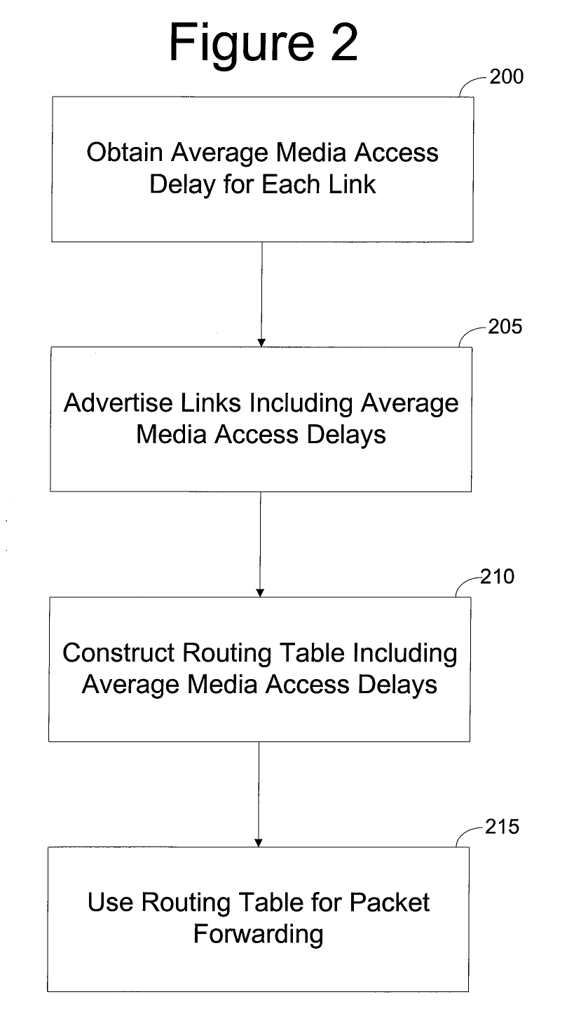

FIG. 2 illustrates a flow diagram of the actions at a node in accordance with one of the embodiments of the present invention utilizing media-access-delay-based link selection to find optimal routes through a MANET. In step 200, the node calculates the average media access delay for each of its links. As discussed above, a particular node's performance may be affected by the aggregate traffic passing through it. For instance, when an individual node has multiple incoming data flows, the node must store incoming packets associated with each of the multiple data flows before it can forward them towards their destinations. This leads to queuing delays for each of the multiple data flows. Also, in a MANET, or any network where each node utilizes the same broadcast medium, contention delays occur. Contention delays are due to multiple nodes simultaneously using the same communication channel. In a MANET, numerous nodes can be transmitting via the same medium, which can cause contention delay to rise. Contention delays experienced by the preceding packets results in an additional queuing delay for packets waiting for transmission. The sum of these queuing delays at both the MAC and IP layers is referred to as the Media Access Delay.

For each packet received at a node, the media access delay is recorded when the packet is sent to the physical layer. Since packet delays exhibit a great deal of variation, steps must be taken to generate relatively stable delay estimates. A suitable averaging technique, such as the exponential averaging technique, can be employed to derive an estimate of the average media access delay for a given link between two specific nodes from the individual delay values recorded for each packet. If packets headed for different neighboring nodes, i.e., via different outgoing links are placed in separate queues, a separate average media access delay value can be obtained for each link of a node. This allows a single node to have different average media access delay values for each of its links. On the other hand, if there is a common queue at the media access layer for all outgoing packets then the average media access delay at a node is the same for each link. In this case, all outbound links of the node are deemed to have the same average media access delay.

Once a node has obtained an average Media Access Delay for each of its links that are considered alive, the process proceeds to step 205. At step 205, each node advertises its links to its neighboring nodes, for example, when utilizing OLSR as the routing protocol, the link advertisements are sent with “Hello” and “Topology Control” messages. The link advertisements include, for each link, a value of the corresponding average Media Access Delay. By attaching this average Media Access Delay along with an availability advertisement, other nodes will have the option of reviewing the values and selecting a route that includes only those links that are currently exhibiting low media access delays.

After the advertising phase, the process continues to step 210. At this step, each node in the MANET constructs a routing table using the link advertisements it has received from other nodes in the network. In one embodiment, while constructing a routing table, a node considers only those links for which the average Media Access Delay is less than a predetermined delay budget, e.g., 30 ms. The delay budget is an acceptable delay that can occur at each link in the source-destination route before the data flow becomes unusable. This is especially important in VoIP data flows where packet delays can cause the voice message being transmitted to become incomprehensible. After determining a subset of acceptable links based upon delay values, a routing table can be constructed using any additional criterion such as minimizing hop count for every source-destination pair. Once routing tables are constructed, packets are forwarded within the network along the routes given by the routing tables (step 215).

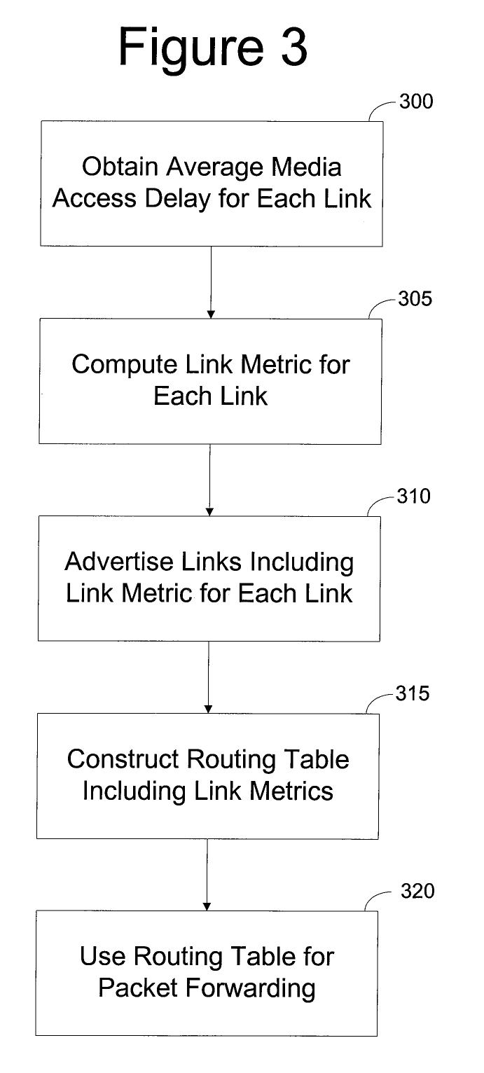

FIG. 3 illustrates a flow diagram of a second embodiment of the present invention. Step 300 of the flow diagram in FIG. 3 is identical to step 200 of the flow diagram of FIG. 2. Here, i.e., in Step 300 of FIG. 3, too, each node obtains an estimate of the average media access delay for each of its links. The methods/algorithms described in the context of Step 200 of FIG. 2 can be employed here as well.

Following Step 300, each node proceeds to Step 305 where it computes a length metric for each of its calculated average media access delays. The length metric for a link is a monotonically non-decreasing function of the corresponding average media access delay. The equation given below is one example of a conversion equation that takes an estimated average media access delay and converts it to a corresponding length metric:

$$Metric = trunc [ 1.5 + \frac{B}{2} + \frac{B}{π} {tan}^{- 1} ( C ( MdAcDly - A ) ) ]$$

where A, B and C are constants chosen based on the desired performance of the MANET. For instance, if a 4-bit binary length metric is desired, a range of 1-15 (in decimal values) results. The constant B is set to the maximum length value minus the minimum length value, or in this case 14. The constant A is selected in accordance with the delay budget for each link. If the delay budget per link is 40 ms, A may be set to 45 ms. This provides for a small additional margin with respect to the delay budget. The constant C determines the shape of the curve in the resulting graph of the length metric as a function of media access delay. The higher the value of C (as it approaches 1), the smaller the slope of the resulting curve. The smaller the value of C (as it approaches 0), the steeper the curve. By setting C to approximately 0.15 ms⁻¹ the resulting graph produces a reasonably steep slope as the graph approaches the delay budget, in this case 40 ms.

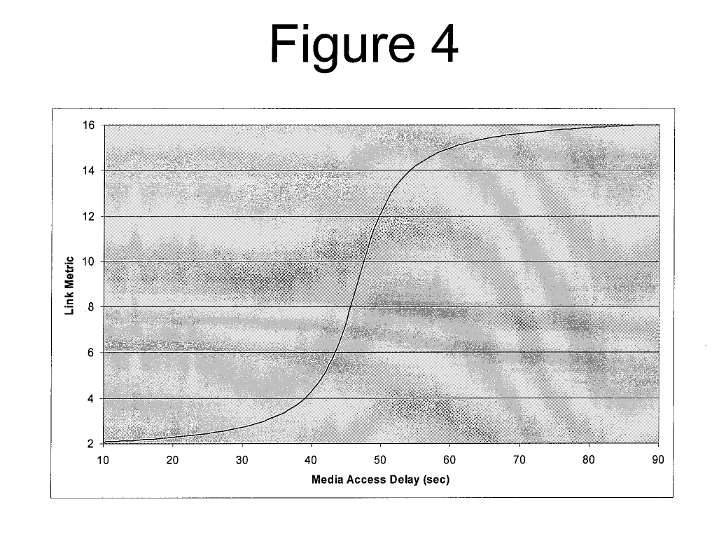

FIG. 4 shows an exemplary graph of the length metric as a function of the average media access delay as calculated by the above equation using the variables as defined above, i.e., A=45 ms, B=14, and C=0.15 ms⁻¹. In this example, the lower the length metric the lower the media access delay is at a node. Thus, a link with a lower length metric is operating with a low media access delay and can be looked upon as better suited for inclusion in routing tables.

Referring again to FIG. 3, once a node has obtained length metrics for each of its outbound links, the process proceeds to step 310. At step 310, each node advertises its links including the corresponding length metrics.

After the advertising phase, the process continues to step 315. At this step, each node in the MANET constructs a routing table using the link advertisements it has received from other nodes in the network. The routing tables are constructed using an algorithm that minimizes path lengths to all destinations within the network. The path lengths in this computation are the sums of the length metrics of the links constituting those paths. Once routing tables are constructed, packets are forwarded within the network along the routes given by the routing tables (step 320). This increases the likelihood that packets will be mostly forwarded along links with small length metrics, i.e. those with small media access delay.

By utilizing routing tables, the construction of which takes into account the predicted media access delay associated with links, the present invention overcomes obvious problems in the prior art. Specifically, in the prior art, a link with excessive media access delay was considered for packet forwarding regardless of its impact on the delays suffered by data packets as they were routed through that link toward the destination. With the present invention, such links are either never considered for packet forwarding or the likelihood of such links being used for packet forwarding is significantly reduced. In either case, one can expect substantial reduction in the end-to-end delays experienced by data packets as they are forwarded toward their destinations in a MANET.

It should be clear to persons familiar with the related arts that the processes, procedures and/or steps of the invention described herein can be performed by a programmed computing device running software designed to cause the computing device to perform the processes, procedures and/or steps described herein. These processes, procedures and/or steps also could be performed by other forms of circuitry including, but not limited to, application-specific integrated circuits, logic circuits and state machines.

The embodiments shown above are merely shown by way of example. One of ordinary skill in the art will recognize additional embodiments and advantages not fully illustrated above. For example, a different equation can be used to calculate a link's length metric or a different delay budget can be set for each link. Accordingly, the breadth and scope of the present invention should be defined only in accordance with the following claims and their equivalents.

1. A method for routing a data flow in a mobile ad-hoc network (MANET) comprising a plurality of nodes and a plurality of links between at least various ones of said nodes of said MANET, the method comprising the steps of:
determining a quantitative value representing the current performance level for each link at a node where the link originates in said MANET;
for each of said links in said MANET, broadcasting from at least its respective originating node said value;
composing a routing table at each of said nodes based upon said values contained in received broadcasts; and
forwarding at least one packet received at one of said nodes in accordance with said node's routing table.

2. The method of claim 1, wherein said value is broadcast in a link state advertisement.

3. The method of claim 2, wherein said value is an average Media Access Delay for each link.

4. The method of claim 2, wherein said value is a link metric calculated based upon an average media access delay for each link.

5. The method of claim 4, wherein said link metric is calculated using the following equation:
$$Metric = trunc [ 1.5 + \frac{B}{2} + \frac{B}{π} {tan}^{- 1} ( C ( MdAcDly - A ) ) ]$$
wherein:
A is a delay budget for each of said links;
B is a total number of possible link metric values;
C determines a shape of a curve of a graph of said link metric as a function of average Media Access Delay; and
MdAcDly is the average Media Access Delay of said link.

6. The method of claim 1, wherein said data flow is a voice over IP (VoIP) data flow.

7. The method of claim 1, wherein said delay value represents a performance level of an entire node.

8. The method of claim 1, wherein said delay value represents a performance level of an individual link.

9. A method for routing a data flow from a source node to a destination node in a mobile ad-hoc network (MANET) comprising a plurality of nodes and a plurality of links between nodes of said MANET, the method comprising the steps of:
each node in said MANET calculating an average Media Access Delay value for each link;
each of said nodes in said MANET advertising each of said links, said advertisement including said average Media Access Delay;
each of said nodes composing a routing table based upon said advertisements, said routing table including only those links in said MANET with associated average Media Access Delay values less than or equal to a predetermined delay budget; and
forwarding packets belonging to said data flow from said source node to said destination node in accordance with said routing table.

10. The method of claim 9, wherein said data flow is a VoIP data flow.

11. A system for routing a data flow in a mobile ad-hoc network (MANET) comprising a plurality of nodes and a plurality of links between at least various ones of said nodes of said MANET, comprising:
means for determining a quantitative value representing the current performance level for each link at a node where the link originates in said MANET;
for each of said links in said MANET, means for broadcasting from at least its respective originating node said value;
means for composing a routing table at each of said nodes based upon said values contained in received broadcasts; and
means for forwarding at least one packet received at one of said nodes in accordance with said node's routing table.

12. The system of claim 11, wherein said value is broadcast in a link state advertisement.

13. The system of claim 12, wherein said value is an average Media Access Delay for each link.

14. The system of claim 12, wherein said value is a link metric calculated based upon an average media access delay for each link.

15. The system of claim 14, wherein said link metric is calculated using the following equation:
$$Metric = trunc [ 1.5 + \frac{B}{2} + \frac{B}{π} {tan}^{- 1} ( C ( MdAcDly - A ) ) ]$$
wherein:
A is a delay budget for each of said links;
B is a total number of possible link metric values;
C determines a shape of a curve of a graph of said link metric as a function of average Media Access Delay; and
MdAcDly is the average Media Access Delay of said link.

16. The system of claim 11, wherein said data flow is a voice over IP (VoIP) data flow.

17. The system of claim 11, wherein said delay value represents a performance level of an entire node.

18. The system of claim 11, wherein said delay value represents a performance level of an individual link.

19. A computer readable product embodied on a computer readable medium for routing a data flow in a mobile ad-hoc network (MANET) comprising a plurality of nodes and a plurality of links between at least various ones of said nodes of said MANET, comprising:
first computer executable instructions for determining a quantitative value representing the current performance level for each link at a node where the link originates in said MANET;
second computer executable instructions for broadcasting from at least its respective originating node said value for each of said links in said MANET;
third computer executable instructions for composing a routing table at each of said nodes based upon said values contained in received broadcasts; and
fourth computer executable instructions for forwarding at least one packet received at one of said nodes in accordance with said node's routing table.

20. The product of claim 19, wherein said value is broadcast in a link state advertisement.

21. The product of claim 20, wherein said source node directs packets belonging to said data flow to said destination node based upon said routing table.

22. The product of claim 21, wherein said value is an average Media Access Delay for each link.

23. The product of claim 21, wherein said value is a link metric calculated based upon an average Media Access Delay for each link.

24. The product of claim 23, wherein said link metric is calculated using the following equation:
$$Metric = trunc [ 1.5 + \frac{B}{2} + \frac{B}{π} {tan}^{- 1} ( C ( MdAcDly - A ) ) ]$$
wherein:
A is a delay budget for each of said links;
B is a total number of possible link metric values;
C determines a shape of a curve of a graph of said link metric as a function of average Media Access Delay; and
MdAcDly is the average Media Access Delay of said link.

25. The product of claim 21, wherein said data flow is a voice over IP (VoIP) data flow.
